(19) United States
(12) Patent Application Publication
(10) Pub. No.: US 2008/0016837 A1
(43) Pub. Date: Jan. 24, 2008

(54) Rotary platform having converging elements for specialty crops

(76) Inventors: Allan Wesley Rosenbalm, Blakesburg, IA (US); Philip Alan Harden, Bloomfield, IA (US); Wendell Wayne Manning, Brownsville, OR (US); Duane Wallace Huppert, Ellensburg, WA (US)

Correspondence Address: DEERE & COMPANY, ONE JOHN DEERE PLACE, MOLINE, IL, 61265, US

(21) Appl. No.: 11/410,454

(22) Filed: Apr. 24, 2006

(51) Int. Cl. A01D 57/30

(52) U.S. Cl. 56/192

(57) ABSTRACT

A rotary platform is provided for the harvest of specialty crops such as grass seed. In particular the conditioning rolls are removed from the header to reduce seed shatter and converging elements are added inside the conditioner opening on both sides and to the rear of the cutterbar to feed the crop around the conditioner opening corner and to the rear of the platform. Additional converging elements are provided behind the first converging elements at a angle less then 90 DEG. to the ground so as to form the top of the windrow so that there is minimal seed loss. The converging elements may or may not be powered and the angle of the second converging element can be adjustable. The rotary knives perform the cutting function more efficiently than a sickle cutterbar, and the converging elements move the crop toward the center to form a windrow with less disturbance.

### FIELD OF THE INVENTION

The present invention relates generally to devices for harvesting crops. More particularly, the present invention relates to such devices for mowing specialty crops. Specifically, the present invention relates to a rotary platform for cutting specialty crops such as grass seed, the platform having converging elements for converging the crop into windrows for later pickup.

### BACKGROUND OF THE INVENTION

In the commercial grass seed business it is current practice to harvest grass seed, after the seed has reached maturity, by first cutting and windrowing the crop with a sickle auger or sickle draper platform on a self-propelled windrower. The grass stems are then allowed to dry prior to combining. Such platforms typically converge and form a windrow with the aid of augers and rod type fingers. These platforms are operated without the conditioning elements and are capable of field operations of 4 to 6 MPH. Rotary platforms on the other hand are capable of over 10 MPH ground speed in the same conditions. However, rotary platforms have not been accepted for grass seed applications because of high grain loss from rotary cutterbar shatter and the windrow formation process. The problems rotary platforms encounter relate to the moving of crop through the conditioner opening and forming a windrow that has the seed head of the crop laid down so the wind will not shatter the seed. Similarly, sickle auger type platforms have higher than desired seed loss from the reel function and auger convergence. Likewise, draper platforms have problems in some conditions forming acceptable windrows. Further, the knife cutting system of sickle type platforms limits cutting speed and productivity in the tough grass conditions, and typically requires changing knives twice a year or more to maintain efficient cutting components, at a significant annual expense. Because the grass seed is susceptible to shatter losses once the crop matures, timely harvest is critical to minimize losses. Accordingly there is a clear need in the art for a system or product to increase productivity, reduce crop losses, and reduce maintenance expenses as desired in grass seed applications.

### SUMMARY OF THE INVENTION

In view of the foregoing, it is an object of the invention to provide an improved rotary platform for cutting and windrowing specialty crops such as grass seed.

Another object of the invention is the provision of such a platform which reduces seed shatter and crop loss during the harvesting process.

A further object of the invention is to provide such a platform that enables the harvest of specialty crops faster and with less fuel consumption.

An additional object of the invention is the provision of such a platform that is compatible with known harvesting techniques.

Most larger rotary platforms use a drum arrangement to convey the crop from the outer most part of the platform to the conditioner opening such as described in U.S. Pat. No. 6,718,743. When the crop reaches the conditioning element the crop is then pulled off the cutterbar and discharged to the rear of the platform. The present invention allows for the use of rotary platforms for the harvest of specialty crops such as grass seed. In the present invention the conditioning rolls are removed from the header to reduce seed shatter. When the conditioning rolls are removed it is very difficult to move the crop from the cutterbar through the conditioner opening. By adding converging elements inside the conditioner opening on both sides and to the rear of the cutterbar it is possible to feed the crop around the conditioner opening corner and to the rear of the platform. By adding further elements at a angle less than 90 DEG. to the ground it is possible to form the top of the windrow so that there is minimal seed loss. These converging elements may or may not be powered and the angle of the further elements can be adjustable. The rotary knives perform the cutting function more efficiently than a sickle cutterbar, and the converging drums move the crop toward the center to form a windrow with less disturbance. In heavy crops, it has been found that windrow formation is very good, and seed shatter loss is visually reduced. In lighter crops, the problem of the lower exit velocity from the cutterbar resulting in a wider than desired windrow as the crop exits the cutterbar area without contacting the forming shields is overcome by the addition of converging elements behind the cutterbar to move the crop into a narrower windrow with the least amount of disturbance.

The rotary cutterbar cuts tough grass much more efficiently and effectively than a sickle cutterbar, allowing much higher cutting speeds and productivity with lower seed shatter losses. This will mean less fuel needed to cut crop and potentially fewer machines required. It has been proven that the invention results in less seed loss then a sickle platform and can operate in wetter conditions. Removing the rolls and using the converging elements to narrow the crop into the desired windrow width is much less disturbing to the crop than using a reel and auger or draper conveyor in combination with a sickle cutterbar to accomplish the cutting and merging functions.

The foregoing and other objects of the invention together with the advantages thereof over the known art which will become apparent from the detailed specification which follows are attained by an improved platform for harvesting specialty crops having a rotary cutterbar the improvement comprising one or more crop converging elements mounted on first and second sides of a crop passage behind the cutterbar.

In general, a rotary platform is provided for the harvest of specialty crops such as grass seed. In particular the conditioning rolls are removed from the header to reduce seed shatter and converging elements are added inside the conditioner opening on both sides and to the rear of the cutterbar to feed the crop around the conditioner opening corner and to the rear of the platform. Additional converging elements are provided behind the first converging elements at a angle less then 90 DEG. to the ground so as to form the top of the windrow so that there is minimal seed loss. The converging elements may or may not be powered and the angle of the second converging element can be adjustable. The rotary knives perform the cutting function more efficiently than a sickle cutterbar, and the converging elements move the crop toward the center to form a windrow with less disturbance.

To acquaint persons skilled in the art most closely related to the present invention, one preferred embodiment of the invention that illustrates the best mode now contemplated for putting the invention into practice is described herein by and with reference to, the annexed drawings that form a part of the specification. The exemplary embodiment is described in detail without attempting to show all of the various forms and modifications in which the invention might be embodied. As such, the embodiment shown and described herein is illustrative, and as will become apparent to those skilled in the art, can be modified in numerous ways within the spirit and scope of the invention—the invention being measured by the appended claims and not by the details of the specification.

### BRIEF DESCRIPTION OF THE DRAWINGS

For a complete understanding of the objects, techniques, and structure of the invention reference should be made to the following detailed description and accompanying drawings, wherein:

FIG. 1 is a top view of a rotary platform according to the invention;

FIG. 2 is a front view of a portion of the rotary platform according to the invention;

FIG. 3 is a rear view of a portion of the rotary platform according to the invention;

FIG. 4 is a top view of a rotary platform according to an alternate embodiment of the invention;

FIG. 5 is a front view of a portion of the rotary platform according to the alternate embodiment of the invention; and,

FIG. 6 is a rear view of a portion of the rotary platform according to the alternate embodiment of the invention.

### DESCRIPTION OF THE PREFERRED EMBODIMENT

With reference now to the drawings it can be seen that a rotary platform is designated generally by the numeral 10 including a body defined by right- and left-hand sidewalls 12 and 14, respectively. Right- and left-hand upright transverse walls or bulkheads (not visible), respectively, extend inwardly from the sidewalls 12 and 14 and terminate at forward ends of right- and left-hand, fore-and-aft extending inner sidewalls 20 and 22 that define a crop passage 24 located centrally between the sidewalls 12 and 14.

An elongate rotary cutterbar 38 extends transversely between the sidewalls 12 and 14. Extending the length of and defining a rear portion of the cutterbar 38 is a tubular stiffener beam 40 of square cross section that is bolted to lower portions of the lower vertical sections, respectively of the transverse walls.

The cutting units are defined by a plurality of cutting units 42 and 44. The cutting units 42 and 44, respectively include cutter discs 52 and 54. The inner sidewalls 20 and 22 are respectively spaced inwardly from the opposite sides of the header 10 between the cutting units 42C and 42D on the one side and between 44C and 44D on the other side. A different relationship between these cutter discs and the sidewalls would be required for cutterbars having more than five cutting units, but the resulting structure would not depart from the principles of the invention.

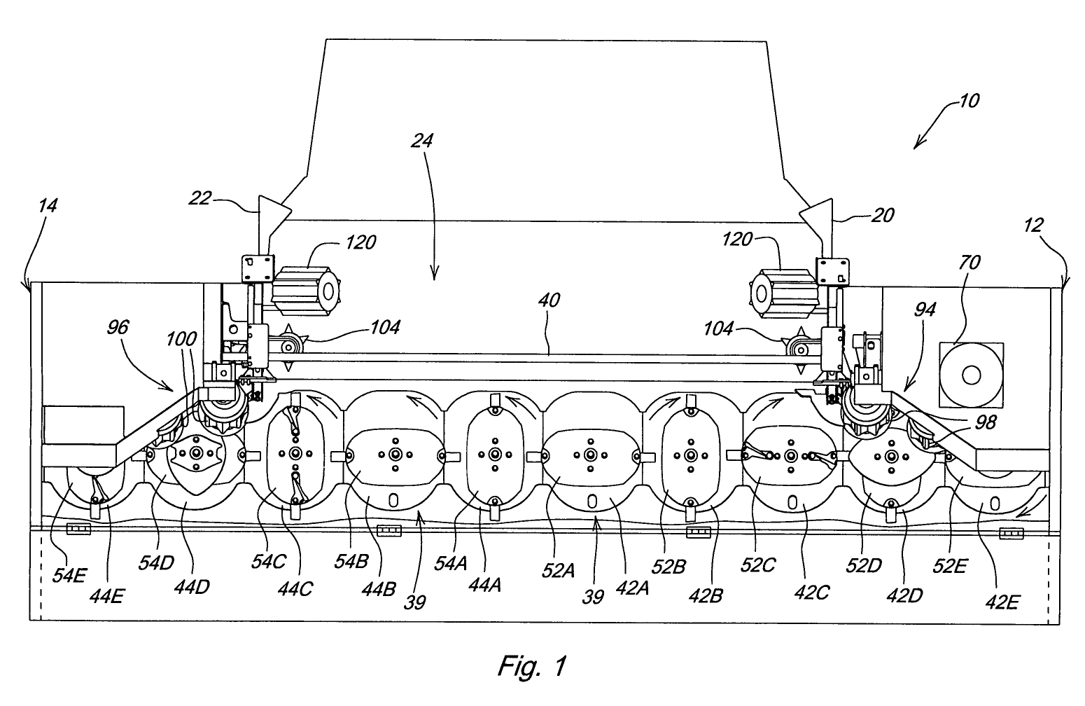

A main power distributing gear box 70 is mounted directly above the cutter disc 54 of the left-hand end cutting unit 42E. The gearing contained in the gear box 70 and cutterbar 38 is arranged such that, as viewed from above in FIG. 1, the left-hand cutter discs 52, are rotated in a clockwise direction while the right-hand cutter discs 54 are rotated in a counterclockwise direction, the respective directions being indicated by arrows. The particular directions of rotation tend to move cut crop toward the crop passage 24.

The movement of crop to the crop passage 24 is enhanced by right- and left-hand convergence structures 94 and 96, respectively, including ribbed drums 98 and 100, respectively. It is noted that in lieu of the drums 98 and 100, cage structures, each defined by ribs extending vertically between upper and lower cylindrical discs, could be used.

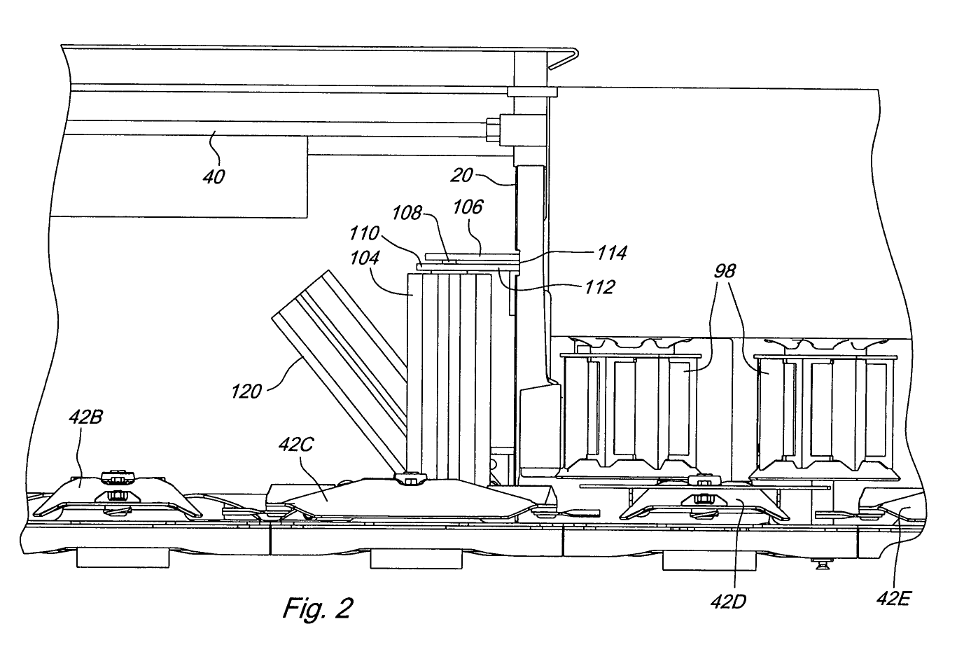

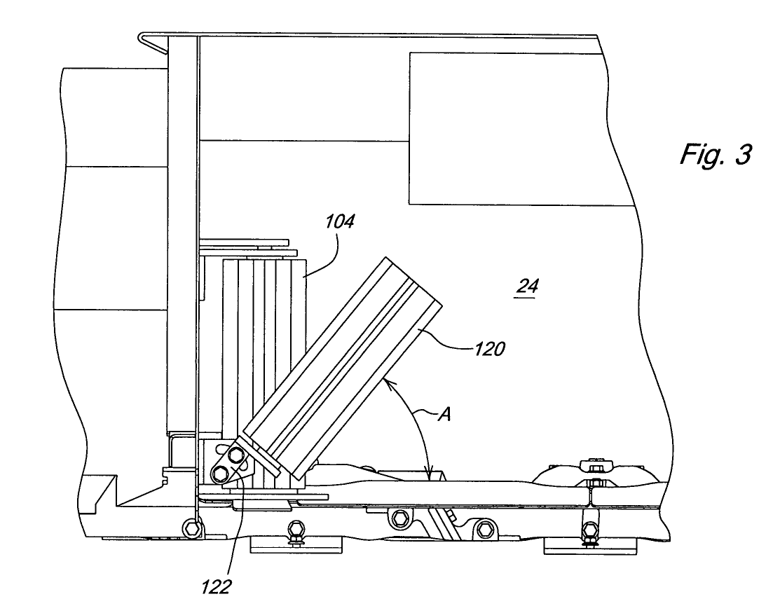

Referring now also to FIGS. 2 and 3, it can be seen that the header 10 further includes a pair of upright converging elements 104 behind the cutterbar 38 and generally in the crop passage 24. More particularly, each converging element 104 is journaled for rotation between upper and lower mounting brackets 106 both mounted to the inner sidewalls 20 or 22 immediately behind the cutterbar 38. As shown the converging elements 104 are ribbed drums, but the elements could have other configurations such as a cage structure. It should be noted that each element 104 includes a drive shaft 108 which is journaled in the upper mounting bracket 106 and extends therethrough, upon which is mounted a driven sheave 110. A V-belt 112 engages the sheave 110 and extends through an opening 114 in the sidewall 20 or 22 to engage a drive sheave (not shown). The drive sheave (not shown) is linked to the gearbox 70 by way of the sheaves (not shown) driving the convergance structures 98 and 100, however those having skill in the art will recognize that there are a number of ways to provide power to the converging elements 104.

Behind each converging element 104 is a second converging element 120. The second converging elements 120 are similar to the converging elements 104 in that they are ribbed drums or cage structures, however, the second converging elements 120 are mounted to the sidewalls 20 or 22 by way of a single hinged bracket 122. More particularly, each second converging element 120 is journaled for free rotation on the bracket 122 which is adapted to provide an adjustable angle A for the element of less than 90 degrees. Thus for reasons which will become apparent as the description continues, the converging elements 120 extend at an angle toward one another in the crop passage 24. It is contemplated that adjustment of the angle of the second converging elements can be accomplished in a number of ways as would be known to those having skill in the art, such as by a pattern of fastener apertures or a slot wherein an adjustment fastener would be disposed to secure the hinge 122 and element 120 at a desired angle or by a hydraulic actuator. While in the specific embodiment shown the second converging elements 120 are non-powered, it is contemplated that the elements 120 could be driven by an appropriate drive linkage to the gearbox or via separate hydraulic or electric motors etc.

In operation of the header 10 in mowing a standing crop, the cutter discs 52 and 54 will be driven such that their respective cutter knives slice through stems of the crop. Due to the counterclockwise rotation of the right-hand cutter discs 52, these discs will tend to move cut crop leftwardly toward the crop passage 24 while clockwise rotation of the left-hand cutter discs 54 will result in these discs tending to move crop rightwardly toward the crop passage 24. This leftward and rightward movement of the cut crop is respectively aided by the right- and left-hand convergence structures 94 and 96, respectively, comprising the right- and left-hand drums 98 and 100.

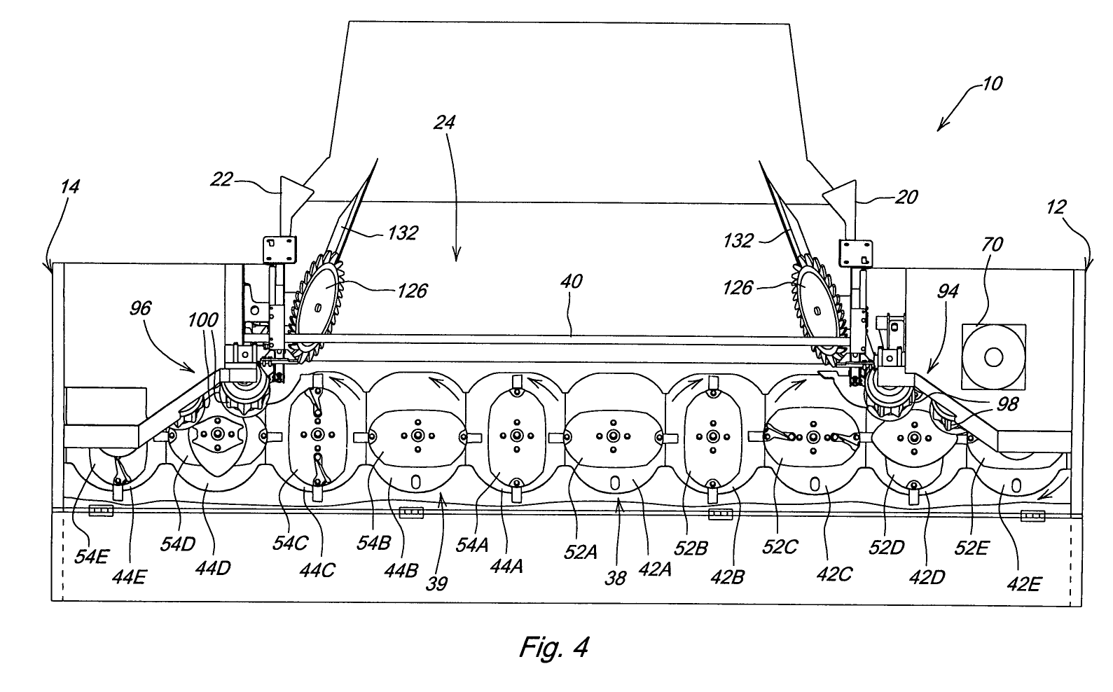

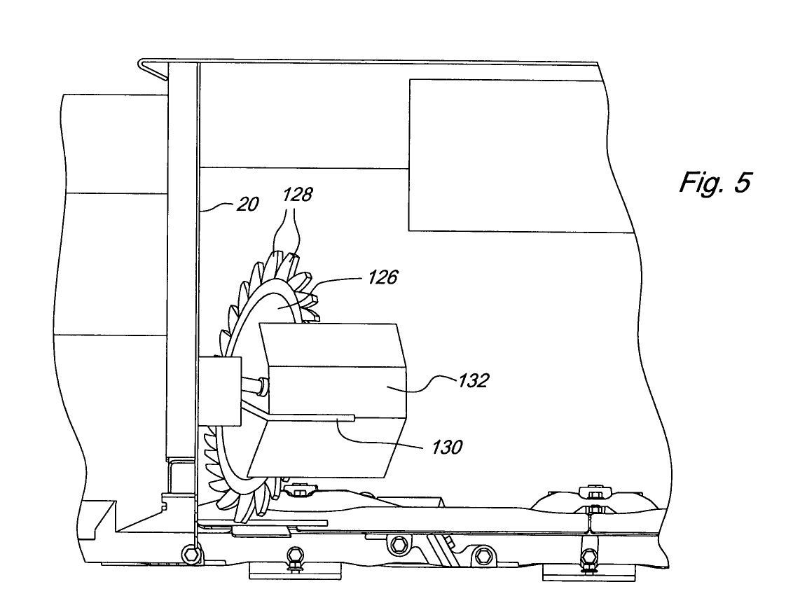

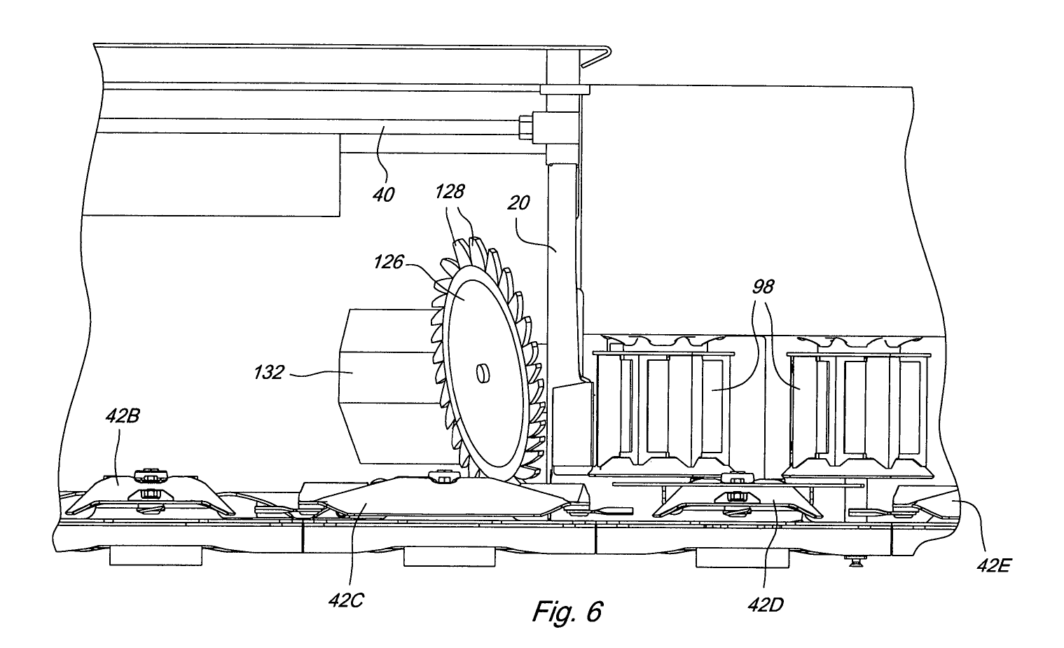

Referring now to FIGS. 4-6 an alternate embodiment of the invention is shown wherein the platform 10 is identical in most respects to that shown in FIG. 1-3 with the exception that the converging elements 104 and 120 of FIGS. 1-3 have in FIGS. 4-6 been replaced with alternative elements that will be described in more detail below. More particularly it will be seen that a rotating wheel 126 with either rubber or spring type teeth 128 is added just behind the cutterbar 38 and next to the crop passage 24. Each wheel 126 is preferably disposed at an angle of less than 90 DEG. to the ground and at an angle of at least 10 DEG. from the respectives sidewall 20 or 22. The wheels 126 are rotatably driven by engagement with the ground and aid in keeping the crop moving around the corner of the crop passage. Due to the angle the wheels 126 also help lay the crop over and roll the crop to form a windrow. It will be seen that behind each wheel 126 there is a rod 130 with a sheet 132 attached to it. The sheets 132 function to compress the top of the windrow down to reduce seed loss. The sheets are preferably made from a UHMW plastic or similar material.

In operation the vehicle supporting the platform is moved over the field of crop and the rotary cutterbar 38 acts to perform the cutting function in a more efficient manner than sickle bar type platforms. Because no conditioning rolls are present on the header, seed shatter is reduced. However without the conditioning rolls it would otherwise be very difficult to move the crop from the cutterbar through the crop passage. Thus the additional converging elements 104 or 126 inside the crop passage on both sides and to the rear of the cutterbar 38 makes it possible to feed the crop around the crop passage corner and to the rear of the platform. The addition of the second converging element 120 at an angle of less than 90 DEG. to the ground makes it possible to form the top of the windrow so that there is minimal seed loss. The angle of the second converging element 120 is adjustable so that the operator can adjust the converging element 120 to create optimal windrows based upon the specific crop, weather, and field conditions. The converging elements 104 and 120 or 126 move the crop toward the center to form a windrow with less disturbance. In heavy crops, it has been found that windrow formation is very good, and seed shatter loss is visually reduced. In lighter crops, the problem of the lower exit velocity from the cutterbar 38 resulting in a wider than desired windrow as the crop exits the cutterbar area without contacting the forming shields is overcome by the addition of the converging elements 104 and 120 or 126 behind the cutterbar to move the crop into a narrower windrow with the least amount of disturbance.

Thus it can be seen that the objects of the invention have been satisfied by the structure presented above. While in accordance with the patent statutes, only the best mode and preferred embodiment of the invention has been presented and described in detail, it is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. An improved platform for harvesting specialty crops having a rotary cutterbar the improvement comprising one or more crop converging elements mounted on first and second sides of a crop passage behind the cutterbar.

6. An improved platform for harvesting specialty crops according to claim 1 wherein each of the one or more crop converging elements comprise an upright rotating ribbed drum structure.

7. An improved platform for harvesting specialty crops according to claim 1 wherein the one or more crop converging elements comprise an upright rotating cage structures.

2. An improved platform for harvesting specialty crops according to claim 1 wherein the one or more crop converging elements are rotatably driven.

8. An improved platform for harvesting specialty crops according to claim 2 wherein the one or more crop converging elements are driven by a gearbox that also drives the cutterbar.

9. An improved platform for harvesting specialty crops according to claim 8 wherein the one or more crop converging elements are drivingly connected to the gearbox by way of a v-belt and sheaves.

3. An improved platform for harvesting specialty crops according to claim 1 wherein the one or more crop converging elements comprise an angled converging element in a crop path on first and second sides of the crop passage.

10. An improved platform for harvesting specialty crops according to claim 1 wherein the one or more crop converging elements comprise a first upright converging element and a second angled converging element behind the first converging element in the crop path on first and second sides of the crop passage.

4. An improved platform for harvesting specialty crops according to claim 3 wherein the angled converging element has angle of less than 90 degrees relative to the cutterbar.

11. An improved platform for harvesting specialty crops according to claim 10 wherein the second converging element has angle of less than 90 degrees relative to the cutterbar.

5. An improved platform for harvesting specialty crops according to claim 3 wherein the angled converging element is rotatably driven.

12. An improved platform for harvesting specialty crops according to claim 10 wherein the second converging element is rotatably driven.

13. An improved platform for harvesting specialty crops according to claim 3 wherein the angled converging element has an adjustable angle.

14. An improved platform for harvesting specialty crops according to claim 10 wherein the second converging element has an adjustable angle.

15. An improved platform for harvesting specialty crops according to claim 1 wherein the one or more converging elements comprise one or more crop converging wheels.

16. An improved platform for harvesting specialty crops according to claim 15 wherein each crop converging wheel includes a plurality of teeth.

17. An improved platform for harvesting specialty crops according to claim 16 wherein the teeth are flexible.

18. An improved platform for harvesting specialty crops according to claim 15 wherein the one or more converging wheels are disposed at an angle of less than 90 degrees to the cutterbar.

19. An improved platform for harvesting specialty crops according to claim 15 wherein the one or more converging wheels are disposed at an angle of at least 10 degrees to the sidewall.

20. An improved platform for harvesting specialty crops according to claim 15 wherein the one or more converging wheels are rotatably driven through engagement with the ground.

21. An improved platform for harvesting specialty crops according to claim 15 wherein one or more crop compressing sheets are disposed behind each converging wheel.

22. An improved platform for harvesting specialty crops according to claim 21 wherein one or more crop compressing sheets are made from a UHMW plastic.
